(19) United States
(12) Patent Application Publication
(10) Pub. No.: US 2007/0205903 A1
(43) Pub. Date: Sep. 6, 2007

(54) Integrated System for Monitoring the Allowable Heat Exposure Time for Firefighters

(75) Inventors: Marino diMarzo, Bethesda, MD (US); Amr M. Baz, Rockville, MD (US)

Correspondence Address: EDELL, SHAPIRO & FINNAN, LLC, 1901 RESEARCH BLVD, SUITE 400, ROCKVILLE, MD, 20850-3164, US

(73) Assignee: University of Maryland, College Park, College Park, MD (US)

(21) Appl. No.: 11/678,694

(22) Filed: Feb. 26, 2007

Related U.S. Application Data
(60) Provisional application No. 60/743,400, filed on Mar. 3, 2006.

(51) Int. Cl. G08B 23/00; G08B 17/00

(52) U.S. Cl. 340/573.1; 340/588

(57) ABSTRACT

The present invention relates to an integrated sensor for monitoring the allowable heat exposure time for firefighters, and to protective equipment containing such a sensor. More specifically, the invention concerns a system for providing a firefighter with improved information as to the firefighter's remaining safe fire exposure time. The system comprises: a sensor for monitoring ambient temperature, moisture transfer, and/or additional data relevant to the firefighter's remaining fire exposure time; a computer processor that is programmed to execute an algorithm for processing the sensed data to determine such remaining fire exposure time; and a warning notification system for communicating such remaining exposure time to the firefighter. In preferred embodiments, the sensor of the present invention monitors thermal conditions at the outer surface of protective equipment and generates information, preferably instantaneously, concerning the maximum allowable residence of an individual in a fire environment. In preferred embodiments, the sensor also records the exposure history and the predicted internal temperature evolution for off-line analysis, such as the analysis desired for the management of skin burns.

### CROSS-REFERENCE TO RELATED PATENT APPLICATIONS

This application claims priority to U.S. Patent Application Ser. No. 60/743,400, filed on Mar. 3, 2006, which application is herein incorporated by reference in its entirety.

### FIELD OF THE INVENTION

The present invention relates to an integrated system for monitoring and reporting a firefighter's remaining safe fire exposure time, and to protective equipment containing such a system. The system comprises: a sensor capable of monitoring a condition relevant to the firefighter's remaining fire exposure time; a warning notification system capable of communicating remaining exposure time to the firefighter; and a computer processor in communication with the sensor and warning notification system. The computer processor receives and processes output from the sensor to calculate the remaining exposure time, and activates the warning notification system to communicate the calculated remaining exposure time to the firefighter.

### BACKGROUND OF THE INVENTION

Although modern firefighter equipment permits the firefighter to remain in a fire location for much longer durations than was previously possible, the efficient insulation of the firefighter garments may impair the ability of the firefighter to assess ambient temperature accurately. Heat may accumulate in the garment and finally “break through” with no advance warning to the firefighter. Various systems have therefore been developed to monitor and alert firefighters to this and other potential dangers. For example, personal alert safety systems (PASS) have been disclosed. In one such system a manually activated “panic button” switch activates an electronic whistle. Other PASS have been described in which non-movement of the firefighter for a preset period is sensed and acts as a trigger to an alarm, or in which the supply of breathable air is monitored (see, U.S. Pat. Nos. 6,310,552; 6,201,475; 5,910,771; 5,689,234; 5,541,579). U.S. Pat. No. 4,914,422 discloses a PASS unit that attaches to the firefighter's shoulder harness and has the ability to audibly indicate temperature changes in 100° F. increments within the hazardous environment (as well as lack of motion by the firefighter). Personal rescue systems, which transmit a rescue demand, or which allow the location of the firefighter to be remotely determined have also been described (see, e.g., U.S. Pat. Nos. 7,005,980; 6,965,344; and 6,952,974). U.S. Pat. No. 6,894,610 discloses a monitoring and warning system for firefighters that comprises warning and control devices as well as a telemetry module for transmitting information to a base station and for receiving commands. The device is designed to monitor temperature, breathable air pressure, toxic and/or explosive gas presence, firefighter motion and location, as well as firefighter vital functions, and to provide alarm and data displays (LED and LCD) as well as acoustic alarms. The Viking SCBA (International Safety Instruments Inc.; Lawrenceville, Ga.) provides a series of face mask mounted LED lights to communicate air cylinder capacity (i.e., full capacity: four lights on; 3, 2 or 1 light to show ¾,½ or ¼ capacity respectively) as well as a low battery indicator light.

As indicated above, however, the delayed impact of heat exposure caused by the insulation capacity of the firefighter's equipment complicates the use, and diminishes the value, of existing thermal sensors in protecting the firefighter from burns and heat stress. Thus, despite existing advances, a need remains for improved sensors for monitoring the allowable heat exposure time for firefighters. The present invention is directed to these and other needs.

### SUMMARY OF THE INVENTION

The present invention relates to an integrated system for monitoring and reporting a firefighter's remaining safe fire exposure time, and to protective equipment containing such a system. The system comprises: a sensor capable of monitoring a condition relevant to the firefighter's remaining fire exposure time; a warning notification system capable of communicating remaining exposure time to the firefighter; and a computer processor in communication with the sensor and warning notification system. The computer processor receives and processes output from the sensor to calculate the remaining exposure time, and activates the warning notification system to communicate the calculated remaining exposure time to the firefighter. In preferred embodiments, the sensor of the present invention monitors thermal conditions at the outer surface of protective equipment and generates information, preferably instantaneously, concerning the maximum allowable residence of an individual in a fire environment. In preferred embodiments, the sensor also records the exposure history and the predicted internal temperature evolution for off-line analysis, such as the analysis desired for the management of skin burns.

In detail, the invention provides an apparatus for providing a firefighter with improved information as to remaining safe fire exposure time, comprising:
(A) a sensor capable of monitoring a condition relevant to the firefighter's remaining fire exposure time;
(B) a warning notification system capable of communicating remaining exposure time to the firefighter; and
(C) a computer processor in communication with the sensor and the warning notification system, wherein the processor receives and processes output from the sensor to calculate the remaining exposure time, and activates the warning notification system to communicate the calculated remaining exposure time to the firefighter.

The invention additionally provides the embodiment of the above-described apparatus wherein the monitored condition relevant to the firefighter's remaining fire exposure time is selected from the group consisting of ambient temperature, the firefighter's skin temperature and moisture transfer. The invention additionally provides the embodiments of the above-described apparati wherein the sensor monitors the condition instantaneously, continuously, periodically, or after a triggering event. The invention additionally provides the embodiments of the above-described apparati wherein the sensor additionally monitors exposure history and predicted internal temperature evolution.

The invention additionally provides the embodiments of the above-described apparati wherein the computer processor is capable of predicting temperature trajectories based on instantaneous thermal readings of ambient temperature. The invention additionally provides the embodiments of the above-described apparati wherein the warning notification system comprises a plurality of LED lights as well as wherein the apparatus is integrated into the visor of the firefighter's protective face mask.

The invention also provides a firefighter fire protective face mask comprising:
(A) a protective face plate providing protected visibility to the wearer, and extending across and cooperating with an annular rim;
(B) a seal member secured to the annular rim and adapted for sealing engagement with the firefighter's face to form a breathing chamber; and
(C) a warning notification system incorporated into the annular rim seal and capable of communicating remaining exposure time to the firefighter, wherein the communicated remaining exposure time is calculated by a computer processor in communication with a sensor, the sensor being capable of monitoring a condition relevant to the firefighter's remaining fire exposure time; wherein the processor receives and processes output from the sensor, and activates the warning notification system to communicate the calculated remaining exposure time to the firefighter.

The invention additionally provides the embodiment of the above-described fire-protective face mask wherein the monitored condition relevant to the firefighter's remaining fire exposure time is selected from the group consisting of ambient temperature, the firefighter's skin temperature and moisture transfer. The invention additionally provides the embodiments of the above-described fire-protective face mask wherein the sensor monitors the condition instantaneously, continuously, periodically, or after a triggering event. The invention additionally provides the embodiments of the above-described fire-protective face mask wherein the sensor additionally monitors exposure history and predicted internal temperature evolution.

The invention additionally provides the embodiments of the above-described fire-protective face mask wherein the computer processor is capable of predicting temperature trajectories based on instantaneous thermal readings of ambient temperature. The invention additionally provides the embodiments of the above-described fire-protective face mask wherein the warning notification system comprises a plurality of LED lights.

### BRIEF DESCRIPTION OF THE FIGURES

FIG. 1 shows the relationship between the ambient temperature and the body temperature of the firefighter.

FIG. 2 shows the circuit layout for a preferred sensor/processor/notification device of the present invention.

FIG. 3 illustrates the systems of the present invention incorporated into a firefighter fire-protective face mask. The Figure depicts the device as seen from the firefighter's perspective. The Protective Head Covering (1) is shown as a fire-protective flexible fabric folded upon itself; in use the covering would be unfolded to cover or protect the firefighter's hair and scalp. The Protective Head Covering is attached to the visor support (2) (comprising a seal member secured to an annular rim, which encloses and supports the transparent Visor (3)). The fire-protective face mask is held onto the firefighter using Fastening Straps (4), that are attached to the mask and attach to one another at the rear of the firefighter's head. An LED Warning Notification System (5) is shown attached to the internal nosepiece (6) of the mask. The illustrated LED Warning Notification System (5) comprises five LEDs (green LEDs are depicted as solid white circles, yellow LEDs are shown as solid gray circles; red LEDs are shown as solid black circles. The five LEDs are shown illuminated as they would be in a test mode.

FIG. 4 shows a comparison of data and calculations based on a simplified gear model.

FIG. 5 shows temperature evolution inside the gear for a 4 minutes exposure with gear surface temperature of 70° C., using calculations based on the model.

### DESCRIPTION OF PREFERRED EMBODIMENTS OF THE INVENTION

Fire protection equipment for firefighters (turnout gear) has advanced to provide a high level of protection through the use of modern materials. Improvements in insulating capabilities have, however, resulted in an increased delay time between the time of a thermal insult and the time that its energy is transported across the gear outer surface to inner layers in contact with the firefighter's skin. This time delay has caused problems since firefighters are not aware of the insult as it occurs, but must survive its long term effect at a later time (2-3 minutes later) (FIG. 1). A consequence of the thermal delay is that mere measurements of the ambient temperature are insufficient to provide adequate warning and protection to the firefighter.

The present invention addresses this problem by providing a system for providing a firefighter with improved information as to the firefighter's remaining safe fire exposure time. The system (i.e., apparatus) comprises:
(A) a sensor capable of monitoring a condition relevant to the firefighter's remaining fire exposure time;
(B) a warning notification system capable of communicating remaining exposure time to the firefighter; and
(C) a computer processor in communication with the sensor and warning notification system, wherein the computer processor receives and processes output from the sensor to calculate the remaining exposure time, and activates the warning notification system to communicate the calculated remaining exposure time to the firefighter.

In preferred embodiments, the sensor of the present invention monitors thermal conditions at the outer surface of protective equipment (such as the ambient temperature) and generates predictions, preferably instantaneously, concerning the temperature distribution inside the firefighter's gear for scenarios of, for example, up to 5 minutes, up to 10 minutes, or for longer periods, into the future. The predicted data will then be transmitted to the display system to display the results for the firefighter and provide warning against excessive exposure. In preferred embodiments, the sensor also records the exposure history and the predicted internal temperature evolution for off-line analysis, such as the analysis desired for the management of skin burns. The apparatus can be incorporated into a fire-protective face mask. A face mask is said to be fire-protective, if it provides a wearer with protection from the fire environment, as by comprising a heat shield, smoke filter, etc., and being constructed of materials suitable and selected for a fire environment.

### A. The Sensor of the Present Invention

The present invention preferably employs an integrated sensor to detect and process temperature and other data in accordance with the algorithms of the invention. More specifically, the sensor of the present invention monitors thermal conditions at the outer surface of protective equipment and/or other relevant information. In preferred embodiments, the sensor also records the exposure history and the predicted internal temperature evolution for off-line analysis, such as the analysis desired for the management of skin burns.

Such detection may be conducted instantaneously, continuously, periodically (e.g., at preset time intervals), or after a triggering event (i.e., exposure to a fire environment for a predetermined period of time, or upon reaching a predetermined ambient temperature), or may be conducted using multiple such approaches (e.g., every 10 seconds after a predetermined ambient temperature has been reached).

Most preferably, such sensors will be incorporated in the self-contained breathing apparatus (SCBA) worn by the firefighter to provide breathable air in the hostile environment of the fire. The SCBA is typically a three piece device composed of a high-pressure tank (e.g., 2200 psi to 4500 psi), a pressure regulator, and an inhalation connection (mouthpiece, mouth mask or face mask), connected together and mounted to a carrying frame. Most preferably, the sensor of the present invention operates passively, without intervention or activation of the user.

In a preferred embodiment, the sensor is imbedded into one of the straps of the breathing apparatus (BA), and provides input to the real time heat exposure time algorithm of the present invention at a sampling rate of, for example, 0.5 or 1 Hz. The algorithm inputs the information and computes all the possible temperature trajectories for increasing residence times from that time on. Once the critical inside conditions are reached, the algorithm identifies the maximum exposure time corresponding to that situation and outputs the information, for example to the LED display. The temperature sensor signal undergoes an A/D conversion on the same PCB containing the processor and the LED display activator. In a sub-embodiment, the output information is broadcast to a fire command center monitoring the firefighter alone or along with other data, such as the identity, location, remaining breathing air, etc. of the firefighter.

### B. The Algorithm and Computer Processor of the Present Invention

To address the problem of thermal delay, the present invention employs a “real time” predictor, based on measured gear surface temperature capable of immediately calculating that residing in a particular environment for more than a set time (e.g., more than 4 minutes) may cause excessive temperatures in the gear at a later time. Further, such a device could provide a calculated maximum allowable residence time based on the thermal history of the gear during the evolution. This information would refer to the gear status in the same way as the air pressure refers to the time available with the breathing apparatus. The predictor uses a computer processor to execute program steps in accordance with an algorithm.

Data processing may be conducted instantaneously, continuously, periodically (e.g., at preset time intervals), or after a triggering event (i.e., exposure to a fire environment for a predetermined period of time, or upon reaching a predetermined ambient temperature), or may be conducted using multiple such approaches (e.g., every 10 seconds after a predetermined ambient temperature has been reached).

The computer algorithm of the present invention is derived in part from the extensive testing of gear by the Maryland Fire and Rescue Institute (MFRI) during the summer and fall of 2005 and predicts the long term response of the gear. This algorithm preferably receives data from a gear outer shell temperature sensor to provide a real time prediction of the maximum exposure time allowed under the given conditions.

The real time heat exposure time algorithm of the present invention is based on the assumption that the relevant fluxes at the gear outer layer are far larger than the fluxes at the inner layer. Measured fluxes of up to 10,000 W/m2 are typical of fire environments while the fluxes inside the gear may reach 5-10 percent of that value. With this in mind the gear could be approximated as an insulated layer exposed to variable temperatures at its surface.

Carslaw and Jager provide a solution for this problem of the form:

$$θ = \frac{π α}{{L}^{2}} {\sum }_{n = 0}^{∞} ( 2 n + 1 ) {( - 1 )}^{n} exp [ - {( π \frac{2 n + 1}{2} )}^{2} \frac{α t}{{L}^{2}} ] {\int }_{0}^{t} exp [ {( π \frac{2 n + 1}{2} )}^{2} \frac{α λ}{{L}^{2}} ] Φ ( λ ) d λ$$

Where: θ is the temperature increase at the firefighter's skin with respect to an arbitrary initial condition (e.g., 37° C.); is the thermal conductivity of the turnout gear; L is the thickness of the turnout gear; n and λ are dummy variables of integration; φ(t) is the temperature on the outside of the turnout gear reference to the initial condition as a function of time; and t is time.

Another approach to the solution of this problem is obtained by explicitly integrating the one dimensional diffusion equation given as:

$$\frac{\partial T}{\partial t} = α \frac{{\partial }^{2} T}{\partial {x}^{2}}$$

Given the initial condition: for t≦0, T=Tᵢₙᵢₜᵢₐₗ and the two boundary conditions of zero flux at x=0 and prescribed time dependent temperature at the boundary x=L.

The algorithm of the present invention calculates a numerical approximation of one-dimensional flow (e.g., heat conduction, moisture transfer; etc.) using a Finite Difference Method:

Tₘ^{t+1}=F₀(Tₘ₊₁^{t}+Tₘ₋₁^{t})+(1−2F₀)Tₘ^{t}

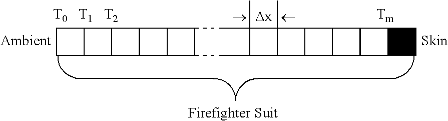

Where F₀ is the Fourier number described by:

$${F}_{0} = \frac{α Δ t}{{( Δ x )}^{2}}$$

$$α Gear Thermal Diffusivity$$

where α is the thermal diffusivity of the turnout gear evaluated experimentally at 4.9×10⁻⁸ m²/s±1.2×10⁻⁸ m²/s; Δt is the time step of the calculation and Δx is the layer thickness shown in the figure. The superscript indices on the temperatures T refer to the time step considered; the subscript indices on the temperatures T refer to the generic location in the gear thickness of the layer considered.

The algorithm of the present invention is illustrated by the programming logic shown below:

```
(Declare and set equation constants)
(Set initial hardware configurations)
(Set timer to run calculations every two seconds)
(On timer interrupt run following code)
{
    (Sample current temperature ten times and take average)
    (Turn on calculation indicator LED)
    (Advance to current temperature distribution)
    (Backup current temperature distribution)
    (Using current distribution, begin approximations for 5
      future scenarios)
    (Loop five times, once for each scenario)
    {
        (Loop by two second intervals until desired scenerio
          is reached)
        {
            (Loop fifteen times, once for each node)
            {
                (Update nodes with Finite Difference
                  equation)
                (Record predicted situation)
            }
        }
        (Restore current distribution)
    }
    (Update Status LEDs)
    (If Immediate Danger Flash Status LEDs)
    (Output status to RS232 for debugging and code
      verification)
    (Turn off calculation indicator LED)
}
```

Significantly, however, the algorithm of the present invention is one that is capable of predicting all of the possible temperature trajectories based on instantaneous thermal readings of the external gear temperature. It is from this predictive array that one selects the first dangerous trajectory and hence deduces the maximum time allowed in the presence of the insult. The algorithm preferably has variable inputs in that the maximum allowable temperature inside the gear can be adjusted to account for the clothing and the thermal properties a specific type of gear.

Variations of the algorithm of the present invention, encompassing additional features, can be generated. For example, the algorithm of the present invention can be readily adapted so that it additionally (or alternatively) allows predictions of moisture transfer across the firefighter's gear. As used herein the term “moisture transfer” refers to moisture transference and/or moisture migration. The algorithm can be adapted to additionally (or alternatively) provide an assessment of the rate of change of the instantaneous assessment of calculated temperature rise (dθ/dt) or moisture transfer change. In embodiments of the invention, the data provided by the algorithm(s) of the invention is associated with additional data (e.g., the location, blood pressure, heartbeat, skin temperature, etc.) of the firefighter. Devices incorporating the algorithm of the present invention may (in addition to providing notification to the firefighter, transmit data to a remote command center (either continuously, or as a firefighter's data crosses a potential danger threshold).

In preferred embodiments, the system will comprise an external port (e.g., a USB, or more preferably, a serial (RS232) port for debugging, correcting, updating, upgrading, and/or downloading data, and for code verification. Where an RS232 port is employed, access may be obtained using a microcontroller universal asynchronous receiver transmitter (UART). The UART signal may be translated into RS232 by a MAX232 chip, and read through the serial port by most computers by a Terminal program such as Hyperterminal. In preferred embodiments, programming will output elapsed time, current ambient temperature, current skin temperature, and status for each scenario.

### C. The Notification Devices of the Present Invention

Any of a variety of notification devices may be employed in order to communicate the results of the data processing to the firefighter. Such devices may be audible signals, visual signals, tactile signals (e.g., vibrations or pulses), etc., or may be any combination of such signals. Notification may be provided solely to the firefighter, to the command leader, or to remote stations (using, for example, radio, or other wireless communication methods).

In a preferred embodiment, a light emitting diode (LED)-based notification system is used to relay the heat exposure information to the firefighter. Preferably, such a system may be incorporated into an in-visor system, such as the LED-based, in-visor system used to monitor air supply (e.g. SCOTT system). For example, an array of multiple LED lights located within the visual field of the firefighter (e.g., on the internal nosepiece of the visor, or at a periphery of the visor) could be used to notify the user as to the environment.

In one embodiment, an array of multiple green lights could indicate that the environment is conducive to unlimited operation. As the gear becomes thermally challenged, either as a continual countdown of exposure time or after a threshold exposure time has been reached (e.g., 10 minute warning), the number of green lights would decrease, change color (e.g., to yellow to indicate warning, or red to indicate a that exit is required), and/or flash, in order to indicate the number of minutes of operation still available in the environment.

In an alternative embodiment, the notification system is configured such that illumination of a single red (calculation) indicator light would signify that an exposure time calculation was being conducted and the notification device would comprise a bank of five LED status (warning) lights: 2 red lights, 2 amber lights and 1 green light. Illumination of all five warning lights would indicate that the minimum remaining fire exposure time was 5 or more minutes. Illumination of both red and one amber warning lights would indicate that 3 minutes of fire exposure time remained. Illumination of only the two red warning lights would indicate that 2 minutes of fire exposure time remain. Illumination of only one of the two red warning lights would indicate that only 1 minute of fire exposure time remain. A blinking illumination of all five warning lights would indicate that the firefighter should immediately exit the fire environment.

In a preferred embodiment, when the last minute of safe operation time has elapsed, all of the LED's would signify (e.g., by flashing or changing color), so as to prompt the firefighter to exit the environment immediately and seek cooling. Cooling can be achieved by hosing down the individual with water or by other means.

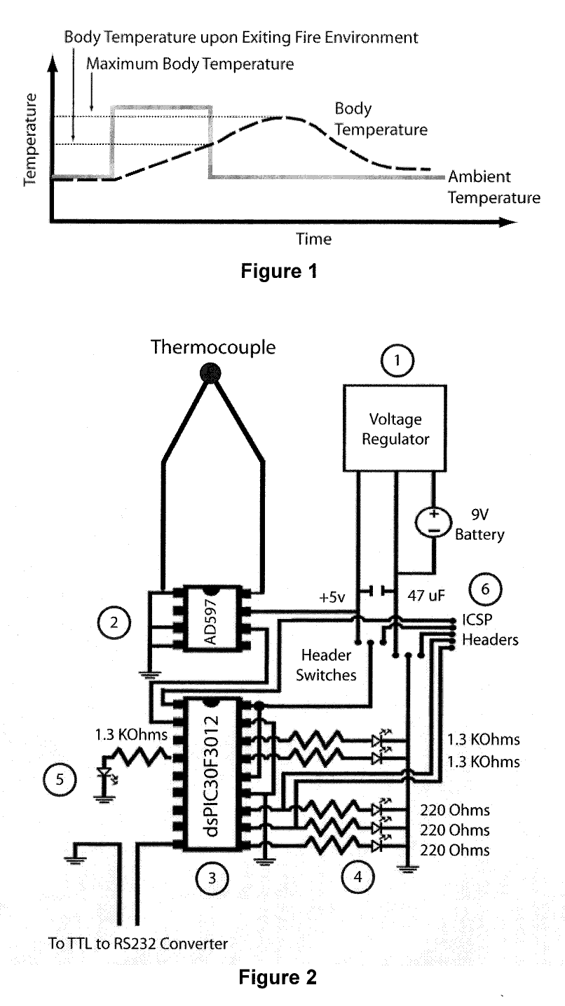

FIG. 2 shows the circuit layout for a preferred sensor/processor/notification device of the present invention. The circuit has six significant features. \textcircled{1} denotes a voltage regulator (for example to step down and regulate an output voltage of 5 volts, suitable for powering the sensor, processor and notification device. \textcircled{2} denotes a signal amplifier for amplifying and conditioning the thermocouple signal. The Analogue Devices 597 (AD597) is a preferred illustrative signal amplifier for use in the present invention. It is designed for Type K thermocouples, has a Small-Outline Integrated Circuit (SOIC) package, provides an analogue output whose sensitivity is +10 mV/° C., and has built-in ice point compensation. \textcircled{3} denotes a microprocessor/microcontroller chip which processes the sensed data (e.g., computing the predicted temperature distribution. The dsPIC30F3012 is a preferred illustrative microprocessor/microcontroller chip for use in the present invention. The chip is an 18-pin Small-Outline Integrated Circuit (SOIC) package having 16 bit architecture, and optimized for C language programming. The chip possesses a 7.37 MHz internal clock with a 16× internal clock multiplier (˜117 MHz total), and implements one instruction per 4 cycles. The dsPIC30F3012 has an RS232 (serial port) interface via a UART port a 12-bit analogue to digital converter and is amenable to In Circuit Serial Programming (ICSP). \textcircled{4} denotes the status (warning) LED lights, which are activated (illuminated) to communicate the predicted status over the following five minutes. \textcircled{5} denotes the calculation LED which illuminates when the microcontroller is making a calculation. In a preferred embodiment a resistor is included in series with each LED in order to reduce power consumption; a capacitor is included in the circuit to reduce circuit noise. \textcircled{6} denotes an in circuit serial programming port which allows the chip to be programmed and or accessed while still soldered into the circuit. The circuit is preferably powered through a 9V battery fed through the voltage regulator, but may be connected to the central power supply carried by the firefighter. Optionally the device will include a status LED, or illumination sequence, to indicate low, adequate, or full battery power.

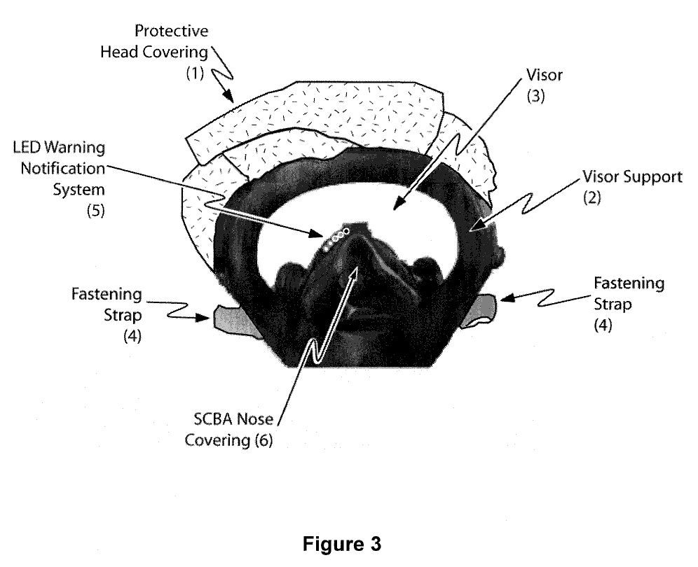

In a preferred embodiment, the integrated system of the present invention is incorporated into the protective gear of the firefighter. Thus, for example, the sensor may be incorporated into the firefighter's outer gear and the status (warning) and notification LEDs may be incorporated into the firefighter's protective face mask (especially a face mask or goggle integrated into a breathing system; FIG. 3). Such a mask will preferably comprise an annular rim; a seal member secured to the annular rim and adapted for sealing engagement with the individual's face; and a face plate extending across the annular rim providing visibility to the individual and cooperating with the annular rim and the seal member to form a breathing chamber when the seal member is in sealing engagement with the individual's face; and optionally, a firefighting hood constructed of a flexible, fire resistant material and configured to be extendible over the head of the individual, the firefighting hood having a face opening for exposing the individual's face to the breathing chamber of the face mask, the face opening defined by an annular edge, the annular edge of the firefighting hood positioned against the face mask in an overlapping relationship; and connecting means secured to at least a portion of each of the firefighting hood and the face mask for detachably connecting the firefighting hood to the face mask so as to secure the annular edge of the firefighting hood to the face mask in the overlapping relationship to prevent exposure of the individual's head to the high heat environment associated with a firefighting site. Exemplary visors that may be modified to incorporate the integrated system of the present invention are described in US20040199981A1; US20030122958A1; U.S. Pat. Nos. 7,110,013; 7,038,639; 6,862,745; 6,691,314; 6,564,384; 6,478,025; 6,098,197; 5,890,236; 5,431,156; 5,404,577 and 5,033,818; WO9911207A1; EP0914839A2. Masks that can be adapted for use in accordance with the present invention include those manufactured by Scott Health & Safety (Monroe, N.C.) (e.g., the Air-Pak® Fifty™ SCBA 2.2/3.0/4.5 and Air-Pak® NxG2™ SCBA), those manufactured by International Safety Instruments Inc. (Lawrenceville, Ga.) (e.g., the Viking SCBA); those manufactured by Survivair (Santa Ana, Calif.) (e.g., the Panther APR-SCBA), and those manufactured by Mine Safety Appliances Co. (Pittsburgh, Pa.) (e.g., the Blackhawk™ Tactical Air Mask (SCBA), FireHawk® Air Mask (SCBA), and AirHawk® MMR Air Mask (SCBA)).

Having now generally described the invention, the same will be more readily understood through reference to the following examples, which are provided by way of illustration and are not intended to be limiting of the present invention unless specified.

### EXAMPLE 1

### Typical Output Generated by the Algorithm of the Present Invention

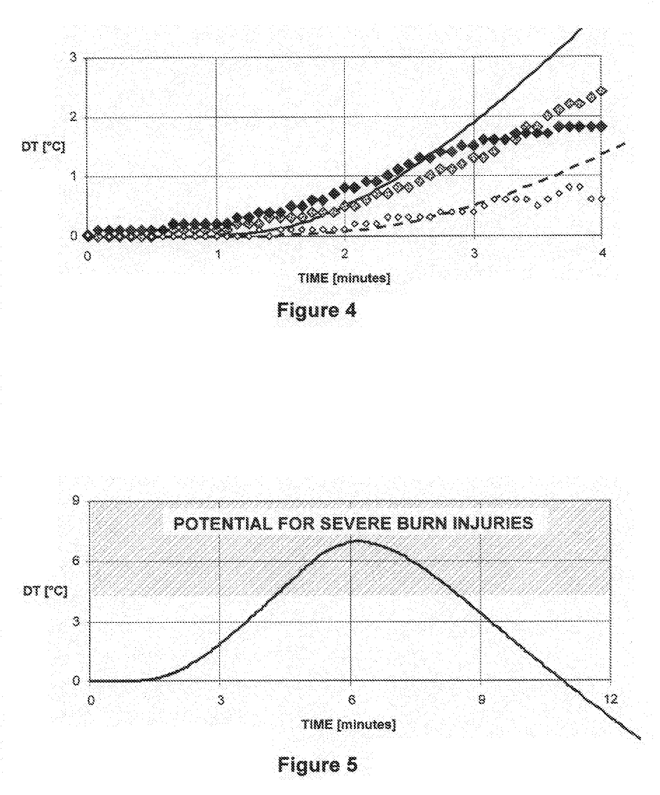

For a typical fire scenario, one can estimate the surface temperature of the gear to be at 70±10° C. With an exposure of 4 minutes, one can predict the temperature rise inside the gear. FIG. 4 shows a comparison of the inside temperature rise compared with actual data. FIG. 5 shows the predicted temperature evolution for the same exposure. Using the algorithm of the present invention, a typical output would appear as follows (the conditions used are those reported on the Toutside (third column) at any given time (first column) the rest is the output of the algorithm based on the nominal thermal diffusivity of 4.9×10⁻⁸ m²/s.

TABLE 1

| | | | Remaining | |
|---|---|---|---|---|
| Time | T_{inside} | T_{outside} | Exposure | |
| [seconds] | [° C.] | [° C.] | Time | Display |
| 0 | 36.0 | 21 | No Problem | 5 Green LEDs [symbol] |
| 10 | 34.8 | 21 | No Problem | 5 Green LEDs [symbol] |
| 20 | 34.3 | 21 | No Problem | 5 Green LEDs [symbol] |
| 30 | 34.0 | 21 | No Problem | 5 Green LEDs [symbol] |
| 40 | 33.6 | 21 | No Problem | 5 Green LEDs [symbol] |
| 50 | 33.3 | 21 | No Problem | 5 Green LEDs [symbol] |
| 60 | 33.1 | 70 | 3 Minutes | 3 Green LEDs [symbol] |
| 70 | 32.9 | 70 | 3 Minutes | 3 Green LEDs [symbol] |
| 80 | 32.6 | 70 | 3 Minutes | 3 Green LEDs [symbol] |
| 90 | 32.4 | 70 | 2 Minutes | 3 Green LEDs [symbol] |
| 100 | 32.2 | 70 | 2 Minutes | 3 Green LEDs [symbol] |
| 110 | 32.0 | 70 | 2 Minutes | 2 Green LEDs [symbol] |
| 120 | 31.9 | 70 | 2 Minutes | 2 Green LEDs [symbol] |
| 130 | 31.7 | 70 | 2 Minutes | 2 Green LEDs [symbol] |
| 140 | 31.6 | 70 | 2 Minutes | 2 Green LEDs [symbol] |
| 150 | 31.5 | 70 | 2 Minutes | 2 Green LEDs [symbol] |
| 160 | 31.4 | 70 | 2 Minutes | 2 Green LEDs [symbol] |
| 170 | 31.3 | 70 | 2 Minutes | 2 Green LEDs [symbol] |
| 180 | 31.3 | 70 | 2 Minutes | 2 Green LEDs [symbol] |
| 190 | 31.3 | 70 | 2 Minutes | 2 Green LEDs [symbol] |
| 200 | 31.4 | 70 | 2 Minutes | 2 Green LEDs [symbol] |
| 210 | 31.5 | 70 | 1 Minute | 1 Green LED [symbol] |
| 220 | 31.6 | 70 | 1 Minute | 1 Green LED [symbol] |
| 230 | 31.8 | 70 | 1 Minute | 1 Green LED [symbol] |
| 240 | 32.0 | 70 | 1 Minute | 1 Green LED [symbol] |
| 250 | 32.2 | 70 | 1 Minute | 1 Green LED [symbol] |
| 260 | 32.4 | 70 | 1 Minute | 1 Green LED [symbol] |
| 270 | 32.7 | 70 | 1 Minute | 1 Green LED [symbol] |
| 280 | 32.9 | 70 | 1 Minute | 1 Green LED [symbol] |
| 290 | 33.2 | 70 | 1 Minute | 1 Green LED [symbol] |
| 300 | 33.5 | 70 | 1 Minute | 1 Green LED [symbol] |
| 310 | 33.8 | 70 | 1 Minute | 1 Green LED [symbol] |
| 320 | 34.2 | 70 | 1 Minute | 1 Green LED [symbol] |
| 330 | 34.5 | 70 | Exit & Cool | 5 Red LEDs [symbol] |
| 340 | 34.8 | 70 | Exit & Cool | 5 Red LEDs [symbol] |
| 350 | 35.2 | 70 | Exit & Cool | 5 Red LEDs [symbol] |
| 360 | 35.5 | 21 | No Problem | 5 Green LEDs [symbol] |
| 370 | 35.9 | 21 | No Problem | 5 Green LEDs [symbol] |
| 380 | 36.2 | 21 | No Problem | 5 Green LEDs [symbol] |
| 390 | 36.6 | 21 | No Problem | 5 Green LEDs [symbol] |
| 400 | 36.9 | 21 | No Problem | 5 Green LEDs [symbol] |
| 410 | 37.3 | 21 | No Problem | 5 Green LEDs [symbol] |
| 420 | 37.7 | 21 | No Problem | 5 Green LEDs [symbol] |
| 430 | 38.0 | 21 | No Problem | 5 Green LEDs [symbol] |
| 440 | 38.3 | 21 | No Problem | 5 Green LEDs [symbol] |
| 450 | 38.7 | 21 | No Problem | 5 Green LEDs [symbol] |
| 460 | 39.0 | 21 | No Problem | 5 Green LEDs [symbol] |
| 470 | 39.2 | 21 | No Problem | 5 Green LEDs [symbol] |
| 480 | 39.4 | 21 | No Problem | 5 Green LEDs [symbol] |
| 490 | 39.6 | 21 | No Problem | 5 Green LEDs [symbol] |
| 500 | 39.8 | 21 | No Problem | 5 Green LEDs [symbol] |
| 510 | 39.9 | 21 | No Problem | 5 Green LEDs [symbol] |
| 520 | 40.0 | 21 | No Problem | 5 Green LEDs [symbol] |
| 530 | 40.0 | 21 | No Problem | 5 Green LEDs [symbol] |
| 540 | 40.1 | 21 | No Problem | 5 Green LEDs [symbol] |
| 550 | 40.1 | 21 | No Problem | 5 Green LEDs [symbol] |
| 560 | 40.1 | 21 | No Problem | 5 Green LEDs [symbol] |
| 570 | 40.0 | 21 | No Problem | 5 Green LEDs [symbol] |
| 580 | 40.0 | 21 | No Problem | 5 Green LEDs [symbol] |
| 590 | 39.9 | 21 | No Problem | 5 Green LEDs [symbol] |
| 600 | 39.8 | 21 | No Problem | 5 Green LEDs [symbol] |
| 610 | 39.7 | 21 | No Problem | 5 Green LEDs [symbol] |
| 620 | 39.6 | 21 | No Problem | 5 Green LEDs [symbol] |
| 630 | 39.5 | 21 | No Problem | 5 Green LEDs [symbol] |
| 640 | 39.3 | 21 | No Problem | 5 Green LEDs [symbol] |
| 650 | 39.2 | 21 | No Problem | 5 Green LEDs [symbol] |
| 660 | 39.0 | 21 | No Problem | 5 Green LEDs [symbol] |
| 670 | 38.9 | 21 | No Problem | 5 Green LEDs [symbol] |
| 680 | 38.7 | 21 | No Problem | 5 Green LEDs [symbol] |
| 690 | 38.5 | 21 | No Problem | 5 Green LEDs [symbol] |
| 700 | 38.4 | 21 | No Problem | 5 Green LEDs [symbol] |
| 710 | 38.2 | 21 | No Problem | 5 Green LEDs [symbol] |
| 720 | 38.0 | 21 | No Problem | 5 Green LEDs [symbol] |
| 730 | 37.9 | 21 | No Problem | 5 Green LEDs [symbol] |
| 740 | 37.7 | 21 | No Problem | 5 Green LEDs [symbol] |
| 750 | 37.5 | 21 | No Problem | 5 Green LEDs [symbol] |
| 760 | 37.3 | 21 | No Problem | 5 Green LEDs [symbol] |
| 770 | 37.2 | 21 | No Problem | 5 Green LEDs [symbol] |
| 780 | 37.0 | 21 | No Problem | 5 Green LEDs [symbol] |
| 790 | 36.8 | 21 | No Problem | 5 Green LEDs [symbol] |
| 800 | 36.6 | 21 | No Problem | 5 Green LEDs [symbol] |
| 810 | 36.4 | 21 | No Problem | 5 Green LEDs [symbol] |
| 820 | 36.3 | 21 | No Problem | 5 Green LEDs [symbol] |
| 830 | 36.1 | 21 | No Problem | 5 Green LEDs [symbol] |
| 840 | 35.9 | 21 | No Problem | 5 Green LEDs [symbol] |
| 850 | 35.8 | 21 | No Problem | 5 Green LEDs [symbol] |
| 860 | 35.6 | 21 | No Problem | 5 Green LEDs [symbol] |
| 870 | 35.4 | 21 | No Problem | 5 Green LEDs [symbol] |
| 880 | 35.2 | 21 | No Problem | 5 Green LEDs [symbol] |
| 890 | 35.1 | 21 | No Problem | 5 Green LEDs [symbol] |
| 900 | 34.9 | 21 | No Problem | 5 Green LEDs [symbol] |

Several important considerations can be made from these results:
1. The firefighter has no feedback from the increase ambient temperature for about 2 minutes or 50% of the exposure time;
2. At the end of the exposure time, the temperature inside the gear has increased 4° C. Although this increase does not place the firefighter at risk of burn injuries, the temperature has reached only half of its excursion due to the insult. This means that in the 2-3 minutes following the exposure, the temperature will increase further before starting to decrease.
3. It is paramount to provide the firefighter with information about these processes, and in particular to provide such information in a fashion that would permit the firefighter to avoid excessive heat exposures.

Note that the maximum internal temperature is reached at about 9 minutes into the event and 3 minutes after the firefighter has exited the fire environment. The value of 40.1° C. while elevated is within the tolerance level. Therefore, this transient is not going to cause any problem to the firefighter.

All publications and patents mentioned in this specification are herein incorporated by reference to the same extent as if each individual publication or patent application was specifically and individually indicated to be incorporated by reference in its entirety.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth.

What is claimed is:

1. An apparatus for providing a firefighter with improved information as to remaining safe fire exposure time, comprising:
(A) a sensor capable of monitoring a condition relevant to the firefighter's remaining fire exposure time;
(B) a warning notification system capable of communicating remaining exposure time to the firefighter; and
(C) a computer processor in communication with said sensor and said warning notification system, wherein said processor receives and processes output from said sensor to calculate said remaining exposure time, and activates said warning notification system to communicate said calculated remaining exposure time to said firefighter.

2. The apparatus of claim 1, wherein said monitored condition relevant to the firefighter's remaining fire exposure time is selected from the group consisting of ambient temperature, said firefighter's skin temperature and moisture transfer.

3. The apparatus of claim 1, wherein said sensor monitors said condition instantaneously, continuously, periodically, or after a triggering event.

4. The apparatus of claim 2, wherein said sensor additionally monitors exposure history and predicted internal temperature evolution.

5. The apparatus of claim 1, wherein said computer processor is capable of predicting temperature trajectories based on instantaneous thermal readings of ambient temperature.

6. The apparatus of claim 1, wherein said warning notification system comprises a plurality of LED lights.

7. The apparatus of claim 1, wherein said apparatus is integrated into the visor of said firefighter.

8. A firefighter fire-protective face mask comprising:
(A) a fire-protective face plate providing protected visibility to the wearer, and extending across and cooperating with an annular rim;
(B) a seal member secured to the annular rim and adapted for sealing engagement with the firefighter's face to form a breathing chamber; and
(C) a warning notification system incorporated into said annular rim seal and capable of communicating remaining exposure time to the firefighter, wherein said communicated remaining exposure time is calculated by a computer processor in communication with a sensor, said sensor being capable of monitoring a condition relevant to the firefighter's remaining fire exposure time; wherein said processor receives and processes output from said sensor, and activates said warning notification system to communicate said calculated remaining exposure time to said firefighter.

9. The fire-protective face mask of claim 8, wherein said monitored condition relevant to the firefighter's remaining fire exposure time is selected from the group consisting of ambient temperature, said firefighter's skin temperature and moisture transfer.

10. The fire-protective face mask of claim 8, wherein said sensor monitors said condition instantaneously, continuously, periodically, or after a triggering event.

11. The fire-protective face mask of claim 9, wherein said sensor additionally monitors exposure history and predicted internal temperature evolution.

12. The fire-protective face mask of claim 8, wherein said computer processor is capable of predicting temperature trajectories based on instantaneous thermal readings of ambient temperature.

13. The fire-protective face mask of claim 8, wherein said warning notification system comprises a plurality of LED lights.
